(19) United States
(12) Patent Application Publication
(10) Pub. No.: US 2008/0275969 A1
(43) Pub. Date: Nov. 6, 2008

(54) System and method for managing a plurality of network clusters

(75) Inventor: Nelson Nicola Saba, Orlando, FL (US)

Correspondence Address: CARR & FERRELL LLP, 2200 GENG ROAD, PALO ALTO, CA, 94303, US

(73) Assignee: Blaksley Ventures 108, LLC

(21) Appl. No.: 12/217,936

(22) Filed: Jul. 9, 2008

Related U.S. Application Data
(63) Continuation-in-part of application No. 11/728,218, filed on Mar. 23, 2007.
(60) Provisional application No. 60/899,092, filed on Feb. 2, 2007.
(60) Provisional application No. 60/959,019, filed on Jul. 9, 2007.

(51) Int. Cl. G06F 15/177

(52) U.S. Cl. 709/220

(57) ABSTRACT

Exemplary systems and methods for managing a plurality of network clusters are provided. In exemplary embodiments, a network cluster is established within a super cluster. Each network cluster comprises one or more groups/organizations having a common interest. Once established, the network cluster defines customized administrative components for the network cluster. These administrative components may define how groups are organized within the network cluster and individual's roles and functionalities within the network cluster. The administrative components may also define what components may be provided to a user associated with the network cluster.

### CROSS-REFERENCE TO RELATE APPLICATIONS

The present application claims priority benefit of U.S. Provisional Patent Application No. 60/959,019, filed Jul. 9, 2007 and entitled “System and Method for Clustering of Group-Centric Networks,” which is incorporated by reference. The present application is also a continuation-in-part of U.S. patent application Ser. No. 11/728,218, filed Mar. 23, 2007 and entitled “Creation of Organizational Hierarchies in a Group-Centric Network via Handshake Mechanisms,” which, in turn, claims the benefit of U.S. Provisional Patent Application No. 60/899,092 filed Feb. 2, 2007 and entitled “Group-Centric Social Network,” both of which are incorporated by reference.

The present application is related to U.S. patent application Ser. No. 12/012,797, entitled “Criteria-Based Creation of Organizational Hierarchies in a Group-Centric Network” and U.S. patent application Ser. No. 12/012,796, entitled “Roles and Relationship Based Security in a Group-Centric Network,” both filed on Feb. 4, 2008, both of which claim the benefit of U.S. Provisional Patent Application No. 60/899,092 and both hereby incorporated by reference. The present application is also related to co-pending U.S. patent applications entitled “System and Method for Clustering of Group-Centric Networks,” and “System and Method for Providing Universal Profiles for Networked Clusters,” filed on Jul. 9, 2008, all of which are herein incorporated by reference.

### BACKGROUND

1. Field of the Invention

Embodiments of the present invention are directed to networking and more particularly to management of a plurality of network clusters.

2. Related Art

Presently, users may utilize social networks to communicate with others in a social environment. These social networks are typically a collection of individuals accessing a single social network host, and typically represent a collection of relationships between the users. In some embodiments, the social network is a map of relationships between the users, which indicate ways in which the users are connected through various social familiarities ranging from casual acquaintance to close familial bonds, for example. The relationships may be created between two users via an invitation or request between the users.

Typically, each user within the social network has their own web page on which any information the user desires to present may be posted. Some information on the web page may be private, such that only those with relationships with the user can view the private information. Other information may be public, such that any member of the social network may be able to view the public information.

Networks of generic users or organization may be present on the Internet. However, these networks are not organized in a manner whereby the networks can be clustered together in multiple ways based on their affinities. Additionally, there are no constructs available to represent organizations robustly enough to allow organizations to be functional over the Internet, by allowing its functions to be performed according to entitlements pertinent to the nature and activity of a group in the organization.

### SUMMARY OF THE INVENTION

Embodiments of the present invention provide systems and methods for managing network clusters. In exemplary embodiments, a plurality of network clusters is established within a super cluster. Each network cluster comprises one or more groups/organizations having a common interest or affinity. As such, each network cluster may be subject matter or topic specific.

A network host may be configured to establish, maintain, and manage the super cluster. In exemplary embodiments, the network host may receive a request to establish a new network cluster in the super cluster. The request may be filtered and approved or denied. Once approved, the network cluster may be established in the super cluster.

An administrator of the network cluster may then define customized administrative components for the network cluster. The customized administrative components may comprise profile segments, web parts, group types, and roles/relationships. These administrative components may define how groups are organized within the network cluster and individual's roles and functionalities within the network cluster. The administrative components may also define what components may be provided to a user associated with the network cluster.

### BRIEF DESCRIPTION OF THE DRAWINGS

FIG. 1 is a diagram of a super cluster according to exemplary embodiments.

FIG. 2a is a block diagram of an exemplary group-centric network cluster.

FIG. 2b is a block diagram of an example group-centric network cluster.

FIG. 3 is a block diagram of an exemplary hierarchical structure within one group-centric network

FIG. 4 is a block diagram of an exemplary super cluster network host.

FIG. 5 is a block diagram of an exemplary accounts engine of the super cluster network host.

FIG. 6 is a block diagram of an exemplary administrative engine of the super cluster network host.

FIG. 7 is a flowchart of an exemplary method for managing a super cluster.

### DETAILED DESCRIPTION OF EXEMPLARY EMBODIMENTS

Embodiments of the present invention provide systems and methods for managing clusters of group-centric networks within a super cluster. For simplicity these group-centric network clusters may be herein referred to as network clusters. In various embodiments, each network cluster is a collection of common-interest or topic group-centric networks associated with a particular subject matter. Each group-centric network allows related organizations to be represented and made functional over a communication network, such as the Internet. Groups, projects, and services of each organization may then be connected through managerial, functional, and business relationships, established within and according to an organizational structure. According to some embodiments, the group-centric network may comprise a group-centric social network. In alternative embodiments, the group-centric network may comprise a group-centric enterprise, business, or educational network, or any other type of group or community based network.

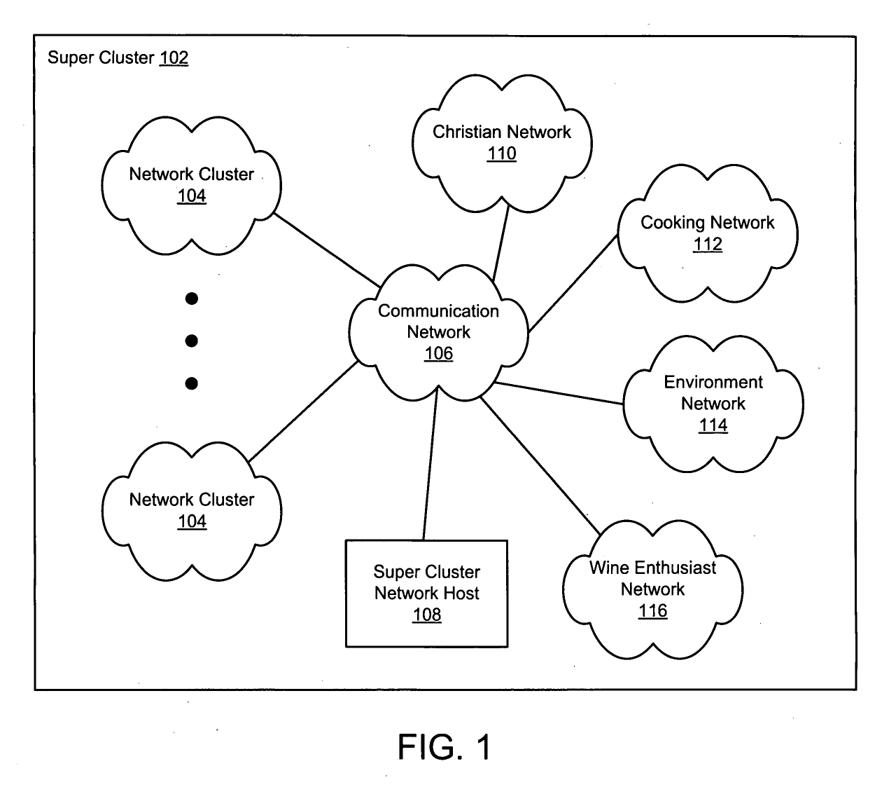

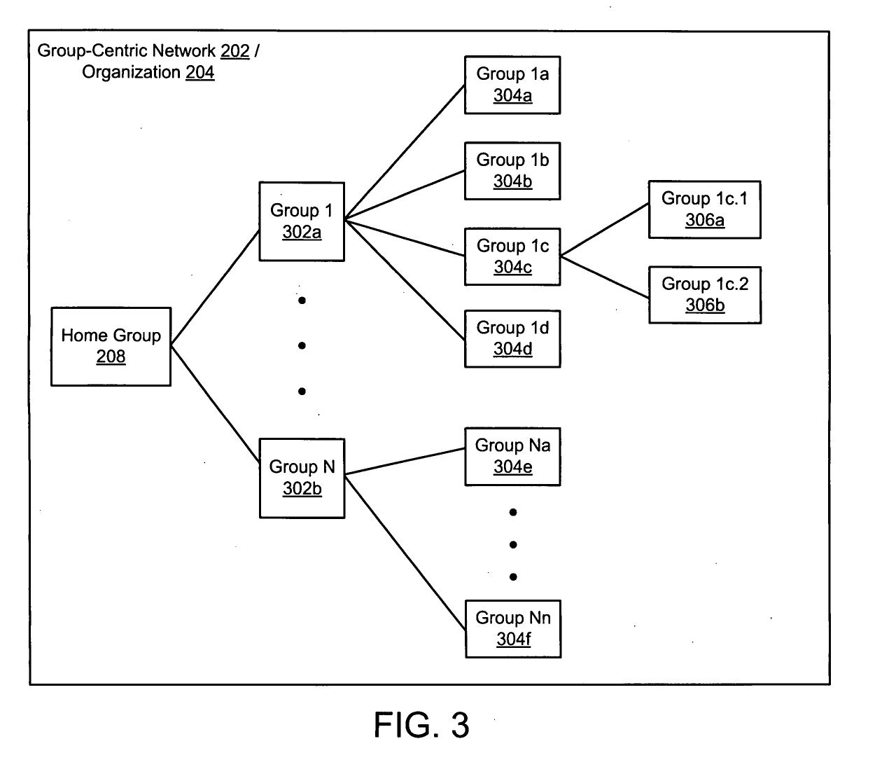

Referring to FIG. 1, a general environment in which embodiments of the present invention may be practiced is shown. In exemplary embodiments, a super cluster 102 comprises a plurality of network clusters 104 coupled in communication in a communication network 106. The super cluster 102 may be administered via a super cluster network host 108, which will be discussed in more detail in connection with FIG. 4 to FIG. 6.

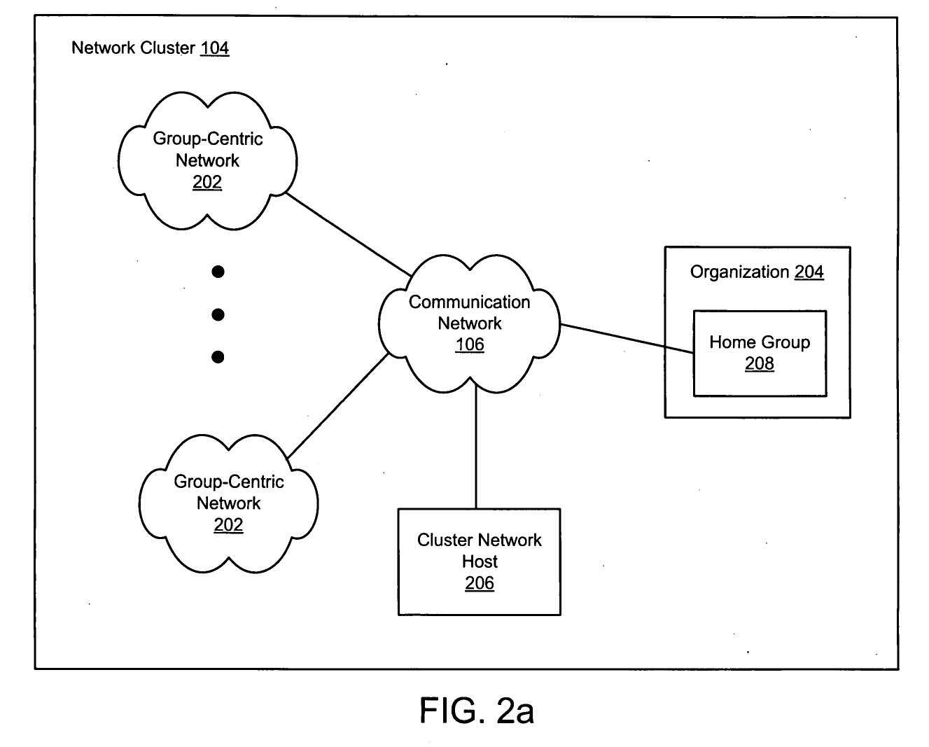

Each network cluster 104 comprises a plurality of related organizations, as will be discussed in more details in connection with FIG. 2a and FIG. 2b. In exemplary embodiments, each network cluster 104 is directed to a particular theme, common goal, or association. For example, the network clusters 104 may represent a Christian network 110, a cooking network 112, an environment network 114, wine enthusiast network 116, or any other collection of organizations or groups having a common interest. As such, the super cluster 102 may be a collection of unrelated network clusters 104.

It should be noted that FIG. 1 illustrates one exemplary embodiment of the super cluster 102. Alternative embodiments may comprise any number of network clusters 104 coupled to any type of communications network 106. Additionally, more than one super cluster network host 108 may be present.

Referring now to FIG. 2a, the network cluster 104 is shown in more detail. The exemplary network cluster 104 comprises a plurality of group-centric networks 202 coupled via the communication network 106. Each group-centric network 202 may represent an organization 204 or specific group(s) of interest. For example, Green Church may be an organization in the Christian network 110, or fusion cooking may be a specific group in the cooking network 112.

The plurality of group-centric networks 202 and organizations 204 may be administered via a cluster network host 206. In exemplary embodiments, the cluster network host 206 comprises one or more servers configured to create and maintain the network cluster 104 of group-centric networks representing organizations 204 and groups within the organizations 204 using various mechanisms to establish the organizations 204, groups, subgroups, and their relationships. These mechanisms may be utilized by the organizations 204, groups, subgroups, and individuals (e.g., members) to set up their presence within the network cluster 104 and the super cluster 102. In some embodiments, the super cluster network host 108 comprises the cluster network host 206.

The organization 204 represents any entity that desires to establish a presence on the network cluster 104. The organization 204 may comprise profit or nonprofit entities, and may be any type of organization, such as businesses, franchises, sponsors, universities, retail chains, advertisers, and partners, city governments and its institutions and citizens, affinity groups, interest groups, or simply groups of people sharing a common interest. The sponsors or partners may be organizations 204 which provide goods or services to other organizations 204 in the network cluster 104.

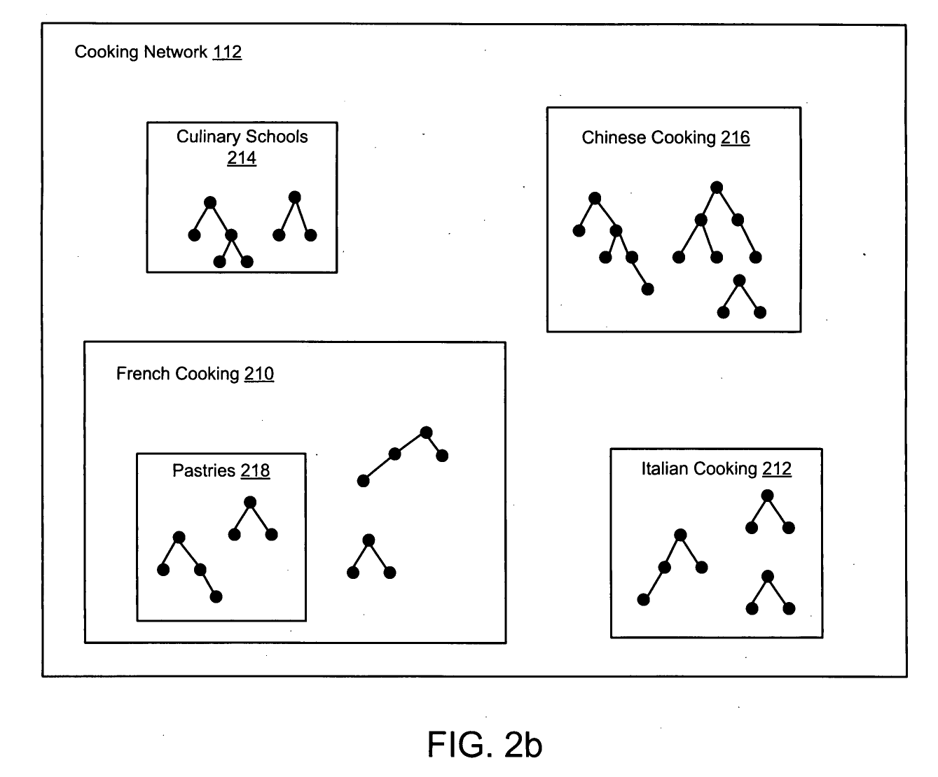

In exemplary embodiments, each organization 204, at a highest level, is represented in the network cluster 104 as a home group 208. The home group 208 is a highest level group in an organization structure that may be established for the organization 204. Each home group 208, in turn, may be linked to one or more subgroups. These subgroups are termed “child groups” of the home group 208 as they are spawns off of the home group 208 or “parent group.” An example of this organizational structure will be discussed in connection with FIG. 3.

It should be noted that FIG. 2a illustrates one exemplary embodiment of the network cluster 104. Alternative embodiments may comprise any number of group-centric networks 202 and organizations 204 coupled to any type of communications network 106. Additionally, more than one cluster network host 206 may be present.

A specific example of a network cluster (i.e., the cooking network 112) is shown in FIG. 2b. The cooking network 112 comprises a plurality of group-centric networks of cooking related organizations or groups. In the present example, the group-centric network includes networks for French cooking 210, Italian cooking 212, culinary schools 214, and Chinese cooking 216. Within each group-centric network 210-216, a plurality of linked groups or subgroups, as will be discussed in more detail in connection with FIG. 3, is present.

In some embodiments, the network cluster 104 may, itself, include one or more secondary network clusters 104 nested within it. For example, the cooking network 112 (i.e., network cluster 104) may comprise a French cooking cluster 210 (i.e., secondary network cluster), which in turn, includes a pastries group-centric network 218. In another example, a car enthusiast network cluster may comprise a sports car secondary network cluster that includes a hot rod group and a Mustang group. Any number of secondary network clusters 104 may be nested within a primary network cluster 104. Furthermore, any number of levels of clustering may be provided. For example, the pastries group-centric network 218 may actually be a pastries network cluster having a croissant group-centric network.

Referring now to FIG. 3, an exemplary organizational structure for the organization 204 (e.g., a group-centric network 202) is shown. The overall organization 204 is represented in the network cluster 104 as the home group 208. The home group 208 may comprise (e.g., be linked to) one or more child groups. In FIG. 3, the home group 208 is shown directly coupled to a plurality of child groups (group 1 302a through group N 302b). Any number of these first level child groups 302 may be coupled to the home group 208. For example, if the organization 204, and thus the home group 206, represents Wood River Church on the Christian network 110, then the child group 1 302a may represent Small Groups Ministry of the Wood River Church. The groups 208 and 302-306 are entities that have a level of importance similar to an individual. That is the groups 208 and 302-306 may comprise profiles, profile pages, web pages, role and relationships (e.g., permission rights set for different roles of members), and catalog of web parts (e.g., components used to build web pages).

Furthermore, each first level child group 302 may be coupled to one or more second level child groups. As shown, child group 1 302a comprises a plurality of second level child groups (e.g., group 1a 304a through group 1d 304d). Similarly, child group N 302b is coupled to a plurality of second level child groups (group Na 304e through group Nn 304f). Any number of second level child groups 304 may be established and coupled to the first level child group 302. As a result, the first level child group 302 becomes a parent to the second level child group 304. Alternatively, the first level child group 302 may not be coupled to any second level child groups 304.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small ministry group.

As further shown, the second level child group 304, itself, may be a parent to third level child groups 306. The organizational structure allows any number of levels of child groups to be established within a single organization 204. Additionally, any number of parent-child relationships may be established within the organizational structure represented on the communication network 106 with any specific child group having one parent.

Each group within the organization 204 (e.g., home group 208, child groups 302-306) as well as each user (e.g., individual member) are defined by its profiles, functions (e.g., web parts), and relationships (e.g., friends, members, etc.). The group's profile may be extended to include profile specific pages for that type of group, and users connected to (e.g., member of) that group may have their personal profiles extended with user information pertinent to that type of group. The group information may include, for example, characteristics, purpose, identification of a group leader, and contact information for the group leader. The user information may comprise contact information, interest areas, photos, etc. Depending on the network cluster 104 and the subject matter of the network cluster 104, profile segments and associated catalog of web parts (e.g., for creating the web pages and providing functionality) for each group 208, 302-306 and user may differ between different network clusters 104.

The profiles or web parts may also comprise security settings for the groups 208, 302-306 as well as for each individual user in the network cluster 104. According to one embodiment, the profile or web parts may comprise general security settings for all data associated with the group 208, 302-306 or user. For example, only logged in group members may be allowed to access data on a group's web page. Alternatively, the profile or web parts may set default security settings for each component on a web page created for the group or user. In some embodiments, the components may comprise different security settings such that some data may be accessed only by group members, and other data, for example, may be accessed by the public or friends. It should be noted that similar profiles, profile segments, and web part functionalities as well as security settings may be applied to network clusters 104.

Each organization 204 may be represented in the network cluster 104 as an organizational structure comprising groups 208, 302-306 networked together through various relationships. These relationships establish how each of the groups 208, 302-306 is coupled within the organizational structure to other groups 208, 302-306 and individual users. Exemplary relationships may comprise line relationships, lateral relationships, staff relationships, functional relationships, group membership relationships, and individual membership relationships. The line relationship comprises a direct parent-child relationship between two groups 208, 302-306 in the organizational structure. For example, there is a parent-child relationship between the home group 208 and first level child group 1 302a.

The lateral relationship comprises a relationship between groups on the same hierarchical level. In the example of FIG. 3, there is a lateral relationship between child group 1 302a and child group N 302b.

The staff relationship comprises a relationship between, for example, an administrative group and other groups 208, 302, 304, or 306 for advisory purposes. For instance, an information technology group may form relationships with a plurality of child groups 302-306 in order to provide technical assistance.

The functional relationship may comprise a relationship between a special purpose group and other groups 208, 302, 304, or 306. In some embodiments, this relationship comprises a line relationship that relates to the special function of the group. In one embodiment, the relationship of the special purpose group (e.g., church store) may allow a member of the special purpose group to access and change data on a webpage of another group. For example, a member of the church store may access and edit advertisement for the church store on a group's webpage.

The group membership relationship comprises a relationship that establishes that a group belongs to an organizational structure. This relationship is, in some embodiments, established with the home group 208 of the organization 204. In other embodiments, membership may be between two independent organizations 204 (each one with its own home group 208), wherein one organization 204 is a member of the other organization 204. An example of this comprises a church denomination and its churches. Both are organization 204 having independent group hierarchies with their own home groups 208. However, there is a membership relationship between the home group 208 of each church (e.g., organization 204) of that denomination and an organization 204 of the church denomination hierarchy. A specific example comprises the Orlando Church of the Nazarene, which is a member of the Nazarene Denomination through a relationship of the Orlando Nazarene Church home group with the group “South East Region” of the Nazarene Denomination hierarchy.

The individual membership relationship comprises relationships established between an individual user and the groups 208, 302-306 making that individual a member of that group 208, 302-306. Members comprise individuals that participate in the group 208, 302-306 in different roles. The roles may comprise leaders, project managers, general members, and so forth. The user may also have a role as a “friend” or as “public” (e.g., not logged in or not a direct member of the group in question).

Furthermore, there may be two types of relationships: within the organization 106 and outside of the organization 204. Within the organization 204, there are relationships between groups 208 and 302-306 (e.g., parent and child) and individual relationships (e.g., member, leaders). Outside of the organization 204, relationships may be established between different organizations 204 (e.g., sponsorship, partnership, etc.). In some embodiments, the establishment of relationships may be based on criteria. For example, if a sponsor is looking to sponsor Baptist churches within a 20 mile radius, then a church (i.e., organization 204) fitting these criteria may establish a relationship with this sponsor.

Once activated, each group 208, 302-306, as well as users, may be represented on the communication network 106 by one or more web pages. These web pages may reflect the group's profile, functions, relationships, leadership, and members. As such, the web pages may be customized by each group 208, 302-306 or user.

It should be noted that all of the relationships described within and between group-centric networks 202 may be applied at the network cluster 104 level. For example, two related network clusters 104 may have a lateral relationship. In another example, one network cluster 104 may be a parent to another network cluster 104 (i.e., nesting of one network cluster 104 in another).

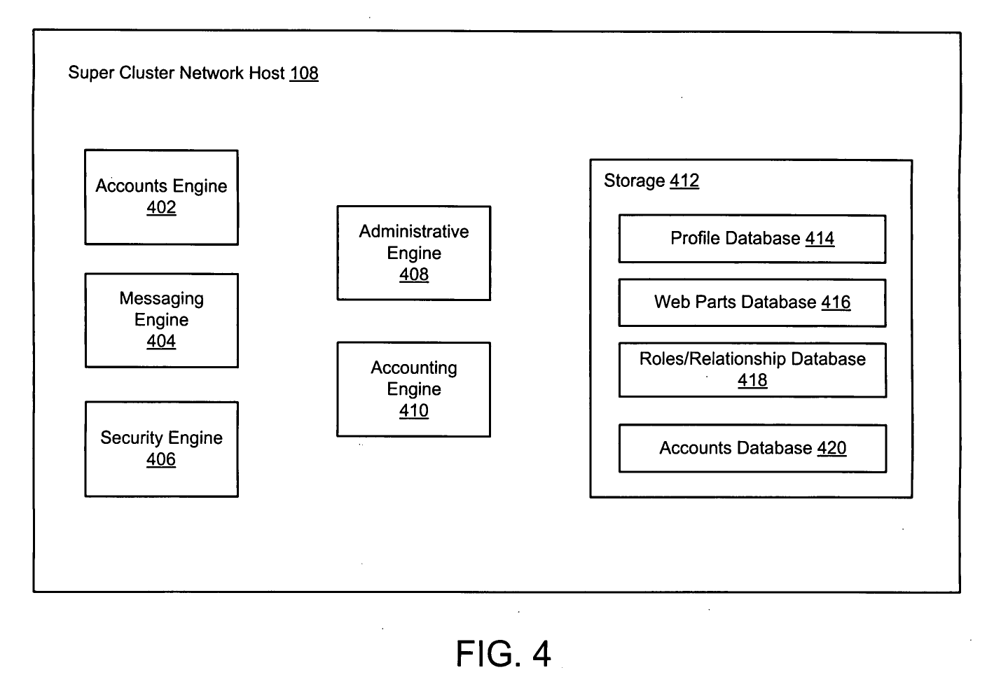

Referring now to FIG. 4, the super cluster network host 108 is shown in more detail. In exemplary embodiments, the super cluster network host 108 comprises an accounts engine 402, a messaging engine 404, a security engine 406, an administrative engine 408, an accounting engine 410, and storage 412. The exemplary accounts engine 402 is configured to manage the network clusters 104 within the super cluster 102, and will be discussed in more details in connection with FIG. 5.

The exemplary messaging engine 404 is configured to provide mechanisms to communicate within the communication network 106 including providing handshake mechanisms for creating, administering, and maintaining the network clusters 110 within the super cluster 104. The messaging engine 404 will, in exemplary embodiments, generate and forward messages (e.g., e-mails) to, and between, individuals (e.g., group leaders, administrative staff, users, etc.) of the network clusters 110. For example, messages may be utilized to establish a new network cluster 110 in the super cluster 104.

In exemplary embodiments, the security engine 406 limits access and functions within the super cluster 102 and network cluster 104. For example, an administrator of the network cluster 104 is allowed to change or define the network cluster 104 profile segments and elements and web parts catalog. However, a general user of the super cluster 102 or member of a network cluster 104 will only be allowed to enter the data in his instance of the profile extensions appended to his original profile.

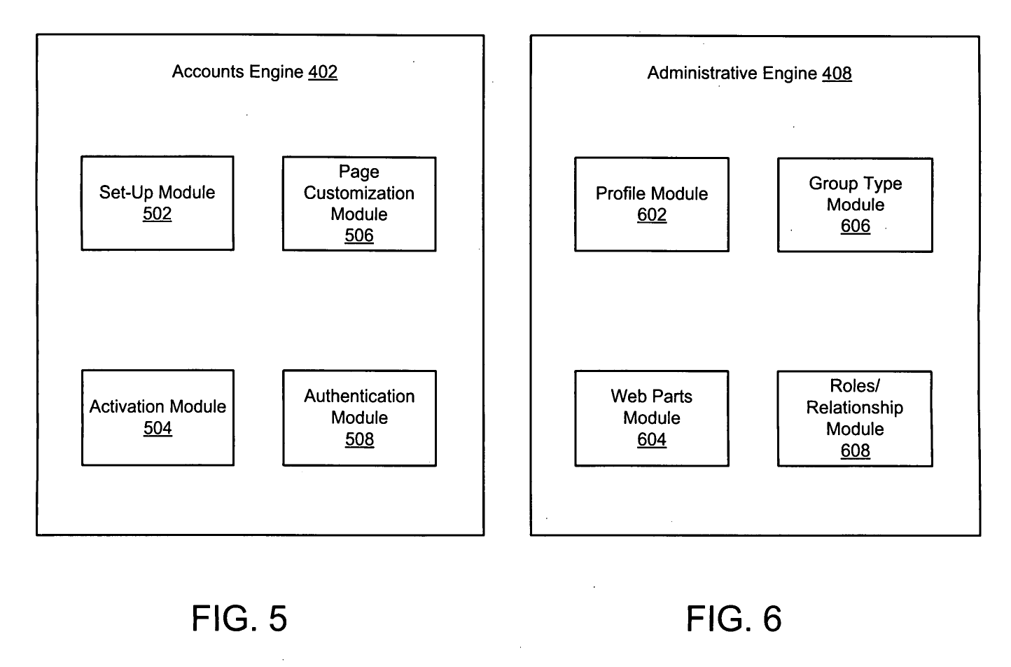

The exemplary administrative engine 408 works with the accounts engine 402 to establish a network cluster 104 in the super cluster 102. Specifically, the administrative engine 408 allows an administrator to define administrative components (e.g., profile segments, web parts, roles) for users and groups in the network cluster 104. In some embodiments, the administrative engine 408 may be a part of the accounts engine 402. The administrative engine 408 will be discussed in more details in connection with FIG. 6.

The exemplary accounting engine 410 is configured to maintain accounting and billing information for each network cluster 104. In various embodiments, each network cluster 104 subscribes to a particular level of service with the super cluster network host 108. The level of service may determine a certain number of megabytes of storage and bandwidth on the communication network 106 and types of features (e.g., customized catalog of web parts) available to the network cluster 104, for example.

The storage 412 is configured to store various databases associated with the super cluster 102 and the network clusters 104. In exemplary embodiments, the storage 412 comprises a profile database 414, web parts database 416, roles/relationship database 418, and accounts database 420. These databases 414-420 are exemplary and alternative embodiments may comprise more or less databases or combine some of the databases 414-420 together. For example, other databases may provide layouts and themes, or store events, news, and blogs for the super cluster 102 or network clusters 104.

The exemplary profile database 414 may store profile information for each network cluster 104 and information associated with an administrator for each network cluster 104. For each network cluster 104, a general profile may be established. In some embodiments, the general profile will comprise default settings including default security settings that will apply to various web part components or data provided by the network cluster 104. The profile database 414 may also comprise profile information for super cluster users (e.g., individual users who are members of the super cluster 102) and/or groups within the network cluster 104 and their members. Profile information may comprise name, contact information, security settings, preferences, attributes, history, and so forth. In some embodiments, the profile database 414 may also comprise defined profile segments associated with the network cluster 104 and the group-centric networks 202, as will be discussed in more detail below.

In exemplary embodiments, the web parts database 416 comprises components that are provided to customize a web page at the super cluster 102 and network cluster 104 level. Icons representing these web parts may be shown, for example, on a pop-up window or on a side of the web page of a super cluster user during web page customization. An administrator for a network cluster 104, for example, can add newly developed cluster specific web parts to the catalog of available web parts in that cluster. If a super cluster user connects to a group on that cluster his catalog of available web parts will be augmented with the web parts made available by the cluster administrator. The user now may drag and drop an appropriate icon onto a location of the web page where the selected component should appear in order to customize his personal page web page. In various embodiments, the web parts components also enable functions on the web pages. In some embodiments, the super cluster web parts available to the network clusters 104 and super cluster users may be generic since the super cluster, itself, is not topic specific. In other embodiments, customized catalogs of web parts that are available to each network cluster 104 may be provided from the web parts database 416.

Each web part component may also allow the individual to select or set a security setting for access to data for that web part. As such, web part security is based on roles and relationships which determine functionality and access rights available to a user accessing the web part on the group or user web page. For example, a network cluster web page may have an events web part. The events web part may be configured to be viewed by anyone (e.g., guests, members), but only members of the network cluster 104 are allowed to register for events. These security settings may not be profile based but are specified by editing the web part settings.

The roles/relationship database 418 may, in some embodiments, store an individual's roles (e.g., responsibilities and permissions within a group) with respect to the super cluster 102 and/or the network cluster 104. These roles may, in one embodiment, be based on relationships between individuals, the super cluster 102, and network cluster 104. These roles may, for example, identify the individual as an administrator (e.g., responsible for technical and administrative maintenance of the network cluster 104). As a result, the role of the individual also determines access and functionalities enabled for the individual within the super cluster 102 and/or network cluster 104.

The exemplary roles/relationship database 418 may also comprise tables storing relationships between the various network clusters 104 and individuals within the super cluster 102. Such relationships may include, but are not limited to, parent-child relationships, sponsor-organization relationships, partner-organization relationships, members-group relationships, and advertise-organization relationships.

The exemplary accounts database 420 is configured to store account information for network clusters 104 and super cluster users. In some embodiments, the account information may include some of the defined administrative components as will be discussed in FIG. 6.

While FIG. 4 has been discussed in relations to the super cluster network host 108, the cluster network host 206 may comprise similar engines, modules, databases, and functionality. For example, some of the data stored at the super cluster 102 level may instead, or in addition, be stored at the network cluster 104 level. That is, each network cluster 104 may comprise their own storage having similar databases for storing the various data. In a further example, the administrative engine 408 may be located at the cluster network host 206. It should also be noted that the embodiment of FIG. 4 is exemplary and that alternative embodiments may comprise more, less, or other functionally equivalent components.

Referring now to FIG. 5, the exemplary accounts engine 402 is shown. The accounts engine 402 is configured to create and maintain network cluster 104 and super user accounts. In exemplary embodiments, the accounts engine 402 comprises a set-up module 502, activation module 504, page customization module 506, and authentication module 508.

The exemplary set-up module 502 is configured to receive a request for account set-up. In exemplary embodiments, the account is for a network cluster 104. In an alternative embodiment, the account may be for a super cluster user. In one embodiment, the request may be received via a graphical user interface. The graphical user interface may provide a plurality of fields where an individual (e.g., network cluster administrator) enters information such as, for example, contact information, type of network cluster 104, description of network cluster 104, and so forth.

Additionally, the set-up module 502 may be configured to filter a network cluster 104 allowed within the super cluster 102. In exemplary embodiments, the request to create a network cluster 104 is completed via a special registration page. An administrator of the super cluster network host 108 may then filter the application and/or content of the application to determine if the network cluster 104 should be approved. In alternative embodiments, filtering and approval of network clusters may be performed automatically based on preset criteria or be performed by the activation module 504.

In exemplary embodiments, the activation module 504 is configured to activate a network cluster 104 within the super cluster 102. The activation module 504 may, in one embodiment, process and approve (or receive approval of) the request for account set-up. Once approved, the activation module 504 may provide the administrator of the network cluster 104 certain functions associated with setting up and maintaining group-centric networks within their network cluster 104. The activation module 504 may also provide a default web page to the network cluster 104 or super cluster user for customization.

In some embodiments, network clusters 104 having similar subject matters may be created. In these embodiments, the similar network clusters 104 may compete with each other for organizations, groups, and members as well as partners, sponsors, and advertisers.

The exemplary customization module 506 is configured to allow the individual to customize the network cluster web page (or super user web page). In exemplary embodiments, a default web page is initially associated with the network cluster 104 or super cluster user. In exemplary embodiments, the customization module 506 provides access to profile segments and a catalog of web parts to a user for customizing their group and/or personal profiles and web pages. When membership is extended to a new group 208 and groups 302-306 or network cluster 104, the customization module 506 may provide the profile extensions (e.g., new profile segments for the new group or network cluster 104) and append the catalog of web parts available to the user to extend their web page. These super cluster web parts may be generic web parts, while network cluster web parts are customized (i.e., defined) for the network cluster 104.

The exemplary authentication module 508 authenticates individuals accessing the super cluster 102. These users may include an administrator for a network cluster 104 or a super cluster user. In some embodiments, the authentication module 508 will verify a user identifier and password for an individual access the super cluster 102 by comparing the user identifier and password with one stored in the profile database 414. Once authenticated, the individual may access data or perform actions based on their roles (e.g., as determined based on data in the roles/relationship database 418) within the super cluster 102.

Referring now to FIG. 6, the exemplary administrative engine 408 is shown. When a network cluster 104 is established within the super cluster 102, components of the network cluster 104 are defined (e.g., the subject matter and content of the network cluster 104). Defining the network cluster 104 comprises defining various administrative components that may be necessary or utilized in the network cluster 104. The administrative engine 408 is configured to establish these customized administrative components for the network cluster 104. These administrative components may include profile segments, web parts, group types, and roles/relationships. As such, each network cluster 104 will have customized administrative components available to their members. The exemplary administrative engine 408 may comprise a profile module 602, web parts module 604, group type module 606, and roles/relationship module 608. It should be noted that in some embodiments the administrative engine 408 may be a part of the accounts engine 402 or be located at the cluster network host 206.

The profile module 602 is configured to define the profile segments for the network cluster 104. The administrator of the network cluster 104 may define and establish the profile segments for their network cluster 104 (e.g., for group-centric networks 202 in the network cluster 104). A profile segment comprises a profile entry or data elements that are directed to a profile of a user. For example, the Christian network 110 may include a profile segment “Your Faith” with specific profile data elements that will describe a user's faith (e.g., church denomination user belongs to). In another example, the environment network 114 may comprise a profile segment on environmental issues with specific data elements such as a profile question, “Do you consider yourself a Dark Green, Light Green, or Bright Green?” Thus, as a user becomes a member of a new network cluster 104, the user's profile may be extended or appended with new profile segments that are established for the new network cluster 104 by the profile module 602. These profile segments may be utilized to generate the user's profile.

It should be noted that profile segments may be established for groups within the network cluster 104. For example, a mission ministry sub-group of a church (i.e., an organization 204) within the Christian network 110 may have a profile segment “Missions.” Thus, if a user joins the mission ministry sub-group, the user's profile may be extended with both the “Your Faith” and “Missions” profile segments, for example.

The web parts module 604 is configured to define the web parts for the network cluster 104. Web parts comprise components or programs used to build customized web pages. Continuing with the previous examples, the Christian network 110 may comprise a “Christian News Wire” web part or “Daily Bible Passage” web part as web part components available to a member of the Christian network 110. By joining the mission ministry group, the user may have access to a “Cause Offering” web part component for the mission ministry sub-group as well as a “Sermons” web part for the church to which the mission ministry sub-group belongs. The administrator of the network cluster 104 may define the web parts for their network cluster 104 and groups within the network cluster 104 via the web parts module 604. These web parts may then be available to members via their catalog of web parts for customizing the user's web page.

The exemplary group type module 606 defines various group types for each network cluster 104. These group types may define the types of groups that are established within the network cluster 104. For example, the Christian network 110 will have a group type “church.” The group type module 606 may also define sub-groups within the network cluster 104. Continuing with the Christian network 110 example, a “mission ministry” sub-group type may be defined for the “church” group type. When a group is created within the network cluster 104, an administrator of the group may assign the group type to the group.

The roles/relationship module 608 is configured to define roles and relationships for the network clusters 104. Each network cluster 104 will have customized roles and relationships. The roles and relationships may be associated with the group types previously defined. For example, the Christian network 110 will have roles such as pastor or youth minister. Similarly, the environment network 114 may have a role called environmentalist. These roles define the users within the cluster network 104. In some embodiments, the roles will have default relationships and functions associated with them. For example, the pastor may have administrative functions for the group the pastor is associated with.

Each network cluster 104, group-centric network 202 (e.g., organization 204), and user may have a profile and web pages, which may be shared with others (e.g., friends, other members of the same organization/group, public, etc.) and a catalog of web parts for building web pages. Each set of web pages may be customized base on the network cluster 104 and/or network clusters that the user is a member of. For example, a user may start as a member of the Christian network 110. As a member of the Christian network 110, the user will have a set of profile segments and certain catalog of web parts used to create associated web page(s). These web parts and profile segments may be directed to the user's faith, area of ministry, and other faith related questions. A user who initially joins, for example, the wine enthusiast network 116 will have a different set of profile segments and catalog of web parts (e.g., wine ratings component, wine tasting notes components, etc.) available for use. That is, the pages will reflect the subject of the network cluster 104 the user is a member of and depend on profile segments selected by the user for generating their profile.

The user may decide to extend their membership to the super cluster 102 (e.g., be positioned in the super cluster 102). From the position within the super cluster 102, the user will have visibility and access to everything in the super cluster 102 (e.g., the other network clusters 104). The user may also extend their membership to other network clusters 104. When the Christian network 110 user extends to the wine enthusiast network 116, for example, the user's profile may be appended with a corresponding wine profile segment, and the catalog of web parts available to the user are appended with web parts that are related to the wine enthusiast network 116. For example, the user may now have a “about my faith” profile segment and a “wines I like” profile segment available for their profile. The extension to another network cluster 104 may be to a group or sub-group within the network cluster 104. The user will then have their profile extended to reflect the group or sub-group he just joined, and will have the associated web parts added to their catalog of available web parts. He will then be able to drag and drop the web parts he desires to his web page.

Each network/cluster (e.g., super cluster 102 and the network clusters 104) may be accessed via a designated portal page. For example, a portal page for the super cluster 102 may be accessed via www.supercluster.com, while the network cluster 104 may have a portal page accessed via www.networkclustername.com (e.g., www.lightstogether.com which an example of a Christian network 110). Specific organization 204 portal pages within a network cluster 104 may be accessed via a link such as www.networkclustername.com/homegroup and to a subgroup (groups 302-306) by www.networkclustername.com/homegroup/subgroup. On any portal page, a user may enter their user identifier and password for authentication.

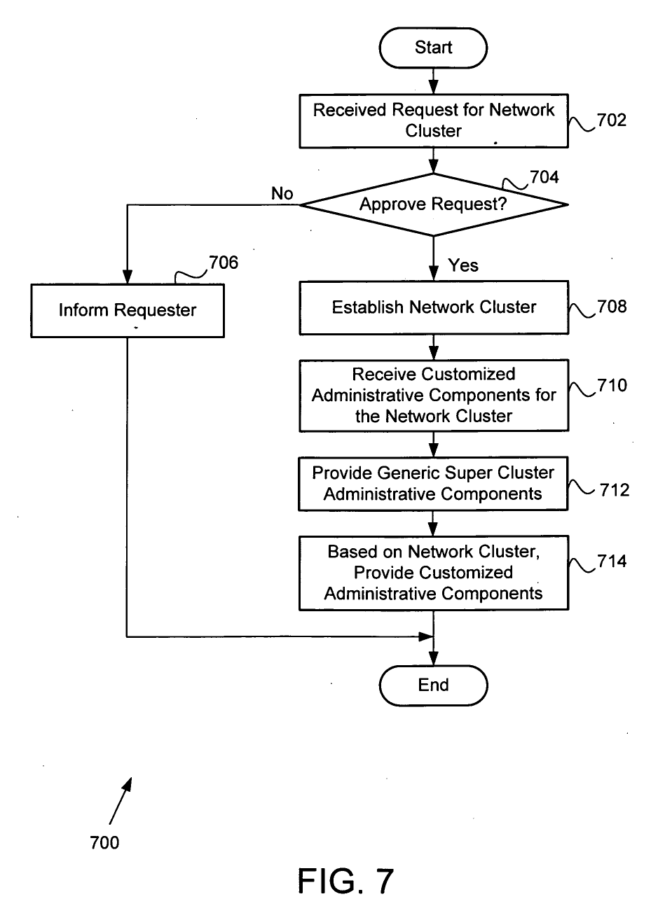

Referring now to FIG. 7, a flowchart 700 of an exemplary method for managing a super cluster 102 is shown. In step 702, a request for establishing a new network cluster 104 is received by the super cluster 102. In exemplary embodiments, the request may be provided from a user (e.g., administrator) interested in creating a new network cluster directed to a particular subject matter. For example, the network cluster may be directed to a particular type of religion, a social cause (e.g., environment), or hobbies (e.g., wine enthusiasts). In one embodiment, the request may be received via an interface provided by the accounts engine 402.

A determination is made in step 704 as to whether the request is approved. In some embodiments, the set-up module 502 is configured to filter the request in order to determine if the subject matter of the requested network cluster 104 is appropriate. The filtering may be based on criteria and may be performed manually or automatically. In other embodiments, a handshake mechanism is performed to determine if the account should be approved. In various embodiments, the handshake mechanism may comprise “belong” handshakes and “join” handshakes. In some embodiments, the handshakes may be provided to a network administrator for the network cluster 104 who will approve or deny the activation of the account. If the account information is provided based on an “invitation” handshake, then the account may be automatically approved and activated.

If the request is not approved, then the user is informed that the network cluster 104 is denied in step 706. In some embodiments, suggestions may be provided to the user to modify aspects of the request (and thus the network cluster 104) in order to result in a request that will be likely approved.

If the request is approved, then in step 708, the network cluster 104 is established in the super cluster 102. In exemplary embodiments, establishing the network cluster 104 may comprise setting up an account with the super cluster 102 and providing certain functionalities to an administrator of the created network cluster 104.

Once the network cluster 104 is established (e.g., account set up), customized administrative components for the network cluster 104 are defined in step 710. In exemplary embodiments, the user/administrator will define administrative components specific to their network cluster 104. The customized administrative components may comprise profile segments, web parts, group types, and roles/relationships. For example, a Christian network may define profile segments (e.g., “My Faith”), web parts (e.g., “Sermons”, “Daily Bible Passages”), group types (e.g., churches, small group ministries), and roles/relationships (e.g., pastor, youth minister).

In step 712, generic super cluster administrative components may be provided. In some embodiments, the generic super cluster administrative components may be provided to the newly established network cluster 104 in order to allow the network cluster 104 to establish a presence on the communication network 106. For example, a catalog of generic web parts may be provided to the administrator of the new network cluster 104. A cluster user or a group administrator may drag and drop select web parts onto his user or group page respectively (i.e., web page) to customize the user or group page in the network cluster 104. Similarly, generic profile segments may be provided.

In step 714, members of the network cluster 104 may be provided access to the customized administrative components established for the network cluster 104 when they join the network cluster 104. Members may comprise individual users, group-centric networks 202 (e.g., organizations 204), or groups/sub-groups established within the group-centric networks 202.

It should be noted that the method of FIG. 7 is exemplary. Alternative embodiments may comprise more, less, or other steps and still be within the scope of the present embodiment. Additionally steps may be practiced in a different order.

The above-described functions and components can be comprised of instructions that are stored on a computer (i.e., machine) storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for managing a plurality of network clusters within a super cluster, comprising:
receiving a request to establish a network cluster within the super cluster; and
establishing the network cluster within the super cluster, the network cluster comprising one or more groups having a common interest.

2. The method of claim 1 wherein establishing the network cluster comprises creating one network cluster nested within another network cluster.

3. The method of claim 1 further comprising defining customized administrative components for the network cluster.

4. The method of claim 3 wherein defining customized administrative components comprises defining profile segments associated with the network cluster.

5. The method of claim 3 wherein defining customized administrative components comprises defining web parts associated with the network cluster.

6. The method of claim 3 wherein defining customized administrative components comprises defining at least one group type associated with the network cluster.

7. The method of claim 6 wherein defining customized administrative components comprises defining at least one sub-group type associated with the at least one group type.

8. The method of claim 3 wherein defining customized administrative components comprises defining roles associated with the network cluster.

9. The method of claim 1 further comprising providing generic administrative components associated with the super cluster.

10. The method of claim 3 further comprising providing customized administrative components associated with the network cluster.

11. The method of claim 1 wherein receiving the request comprises filtering the request in order to determine if the request is for an appropriate network cluster.

12. A system for clustering a plurality of network clusters within a super cluster, comprising:
a set-up module configured to receive a request to establish a network cluster within the super cluster; and
an activation module configured to establish the network cluster within the super cluster, the network cluster comprising one or more groups having a common interest.

13. The system of claim 12 further comprising an administrative engine configured to define customized administrative components for the network cluster.

14. The system of claim 13 wherein the administrative engine comprises a profile module configured to define one or more profile segments associated with the network cluster.

15. The system of claim 13 wherein the administrative engine comprises a web parts module configured to define one or more web parts associated with the network cluster.

16. The system of claim 13 wherein the administrative engine comprises a group type module configured to define one or more group or sub-group types associated with the network cluster.

17. The system of claim 13 wherein the administrative engine comprises a roles/relationship module configured to define one or more roles or relationships associated with the network cluster.

18. The system of claim 12 further comprising a customization module configured to allow the network cluster to establish a customized presence in the super cluster.

19. The system of claim 18 wherein the customization module is further configured to provide profile segments and web parts in order to customize a page within the super cluster.

20. A machine-readable medium having embodied thereon a program, the program having instructions operable by a machine for managing a plurality of network clusters within a super cluster, the method comprising:
receiving a request to establish a network cluster within the super cluster; and
establishing the network cluster within the super cluster, the network cluster comprising one or more groups having a common interest.
